(19) United States
(12) Patent Application Publication
(10) Pub. No.: US 2025/0033996 A1
(43) Pub. Date: Jan. 30, 2025

(54) WATER PURIFIER

(71) Applicant: SAMSUNG ELECTRONICS CO., LTD., Suwon-si (KR)

(72) Inventors: Jungha PARK, Suwon-si (KR); Gimun GWAK, Suwon-si (KR); Chulwoo PARK, Suwon-si (KR); Sujin SEONG, Suwon-si, Gyeonggi-do (KR); Hyunjun CHUNG, Suwon-si (KR)

(21) Appl. No.: 18/785,790

(22) Filed: Jul. 26, 2024

Related U.S. Application Data
(63) Continuation of application No. PCT/KR2024/009294, filed on Jul. 2, 2024.

(30) Foreign Application Priority Data
Jul. 27, 2023 (KR) 10-2023-0098538

(51) Int. Cl. C02F 1/00; C02F 103/00

(52) U.S. Cl. CPC C02F 1/001; C02F 2103/002; C02F 2201/005; C02F 2209/003; C02F 2303/16

(57) ABSTRACT

Provided is a water purifier including: a raw water flow path into which water flows from outside; a filter configured to filter the water introduced from the raw water flow path; a purified water flow path configured to discharge the water having passed through the filter; a drain flow path through the water discharged from the filter through the wastewater flow path is discharged; a resistance valve configured to reduce a flow rate of the drain flow path; a first connection flow path connecting the raw water flow path to a downstream side of the resistance valve on the drain flow path; a second connection flow path connecting the purified water flow path to an upstream side of the resistance valve on the drain flow path; and a tank arranged on the second connection flow path. During washing of the filter, the water stored in the tank flows into the filter via the upstream side of the resistance valve on the drain flow path, and the water flowing into and through the filter is discharged to the outside through the raw water flow path, the first connection flow path, and the downstream side of the resistance valve on the drain flow path.

### CROSS-REFERENCE TO RELATED APPLICATIONS

This application is a continuation of International Application No. PCT/KR2024/009294 designating the United States, filed on Jul. 2, 2024, in the Korean Intellectual Property Receiving Office, and claiming priority to Korean Patent Application No. 10-2023-0098538, filed on Jul. 27, 2023, in the Korean Intellectual Property Office, the disclosures of each of which are incorporated by reference herein in their entireties.

### BACKGROUND

### Field

The present disclosure relates to a water purifier, and for example, to a water purifier capable of washing a filter.

### Description of Related Art

A water purifier is a device that filters incoming water through one or more water filters and supplies wash water to users. Water filters filter out various types of contaminants, and the contaminants may accumulate inside the water filters. In this case, the filtration function of the filter may be lowered or water may not smoothly flow within the filter, which may prevent or reduce the amount of purified water from reaching a level desired by the user. Additionally, microorganisms introduced along with contaminants may proliferate using internal organic substances as nutrients, thus leading to odor and off-flavor in the purified water. Replacing a water filter with a new one incurs user inconvenience and costs.

### SUMMARY

Embodiments of the disclosure provide a water purifier including a filter including a wastewater flow path and capable of washing the filter.

Embodiments of the disclosure provide a water purifier capable of washing a filter without removing the filter through control of components.

Embodiments of the disclosure provide a water purifier capable of selectively washing a filter with a short replacement cycle among a plurality of filters.

Embodiments of the disclosure provide a water purifier capable of washing a filter at a relatively high flow rate without passing through a resistance valve.

According to an example embodiment, a water purifier is provided, the water purifier including: a raw water flow path, including at least one valve, into which water is introduced from outside; a filter configured to filter the water introduced from the raw water flow path, and including a wastewater flow path therein; a purified water flow path, including at least one valve, through which the water having passed through the filter is discharged to the outside; a drain flow path, including at least one valve, connected to the wastewater flow path of the filter and through which the water discharged from the filter through the wastewater flow path is discharged; a resistance valve arranged on the drain flow path and configured to reduce a flow rate of the drain flow path; a first connection flow path, including at least one valve, connecting the raw water flow path to a downstream side of the resistance valve on the drain flow path; a second connection flow path, including at least one valve, connecting the purified water flow path to an upstream side of the resistance valve on the drain flow path; and a tank configured to store water passed through the filter, and arranged on the second connection flow path, wherein during washing of the filter, the water stored in the tank is configured to flow into the filter via the upstream side of the resistance valve on the drain flow path, and the water flowing into and through the filter is configured to be discharged to the outside through the raw water flow path, the first connection flow path, and the downstream side of the resistance valve on the drain flow path.

According to an example embodiment a water purifier includes: a raw water flow path, including at least one valve, into which water is introduced from the outside; a filter configured to filter water introduced from the raw water flow path and including a wastewater flow path therein; a purified water flow path, including at least one valve, configured to discharge the water passed through the filter to the outside; a drain flow path, including at least one valve, connected to the wastewater flow path of the filter and along which water discharged from the filter through the wastewater flow path is configured to be discharged; a resistance valve arranged on the drain flow path and configured to reduce a flow rate of the drain flow path; a first connection flow path, including at least one valve, connecting the raw water flow path to a upstream side of the resistance valve on the drain flow path; and a second connection flow path, including at least one valve, connecting the raw water flow path to the drain flow path while bypassing the first connection flow path, the second connection flow path configured to connect a downstream side of a branch point of the first connection flow path on the raw water flow path to a downstream side of the resistance valve on the drain flow path. During washing of the filter, water in the raw water flow path may be introduced into the filter through the first connection flow path and an upstream side of the resistance valve on the drain flow path, and the water flowing into and through the filter may be discharged to the outside through the raw water flow path, the second connection flow path, and a downstream side of the resistance valve on the drain flow path.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of a water purifier according to various embodiments;

FIG. 2 is a diagram illustrating an example flow of water in the water purifier during supply of purified water according to various embodiments;

FIG. 3 is a diagram illustrating an example flow of water in the water purifier during supply of water to a tank according to various embodiments;

FIG. 4 is a diagram illustrating an example flow of water in the water purifier during washing of a filter according to various embodiments;

FIG. 5 is a block diagram illustrating an example configuration of the water purifier according to various embodiments;

FIG. 6 is a table illustrating an example method of controlling valves and pumps according to each mode in the water purifier according to various embodiments;

FIG. 7 is a cross-sectional view illustrating example flow of water inside a filter during supply of purified water according to various embodiments;

FIG. 8 is a cross-sectional view illustrating example flow of water inside the filter during washing of a filter according to various embodiments;

FIG. 9 is a diagram illustrating an example configuration a water purifier according to various embodiments;

FIG. 10 is a diagram illustrating example flow of water in a water purifier during supply of purified water according to various embodiments;

FIG. 11 is a diagram illustrating example flow of water in the water purifier during discharge of residual water according to various embodiments;

FIG. 12 is a diagram illustrating example flow of water in the water purifier during washing of a filter according to various embodiments;

FIG. 13 is a block diagram illustrating an example configuration of the water purifier according to various embodiments; and

FIG. 14 is a table illustrating an example method of controlling valves according to each mode in the water purifier according to various embodiments.

### DETAILED DESCRIPTION

The various example embodiments of the disclosure and terminology used herein are not intended to limit the technical features of the disclosure to the specific embodiments, but rather should be understood to cover all modifications, equivalents, and alternatives falling within the concept and scope of the disclosure.

In the description of the drawings, like numbers refer to like elements throughout the description of the drawings.

The singular forms preceded by “a,” “an,” and “the” corresponding to an item are intended to include the plural forms as well unless the context clearly indicates otherwise.

In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase of the phrases, or any possible combination thereof.

The term “and/or” includes combinations of one or all of a plurality of associated listed items.

As used herein, such terms as “1st” and “2nd,” or “first” and “second” may be used to simply distinguish a corresponding component from another, and does not limit the components in other aspect (for example, importance or order).

When one (e.g., a first) element is referred to as being “coupled” or “connected” to another (e.g., a second) element with or without the term “functionally” or “communicatively,” it refers to that the one element is connected to the other element directly, wirelessly, or via a third element.

It will be understood that the terms “include”, “comprise” and/or “have” when used in this disclosure, specify the presence of stated features, integers, steps, operations, elements, and/or components, but do not preclude the presence or addition of one or more other features, integers, steps, operations, elements, components, and/or groups thereof.

It is to be understood that if a certain component is referred to as being “coupled with,” “coupled to,” “supported on” or “in contact with” another component, it refers to that the component may be coupled with the other component directly or indirectly via a third component.

In the disclosure, it will be understood that, when an element is referred to as being “on/under” another element, it may be directly on/under the other element, or one or more elements may also be present.

In this disclosure, the terms “front,” “rear,” “upper,” “lower,” right,” and “left” are defined based on the directions illustrated in the drawings, but the terms may not restrict the shape and position of the respective components.

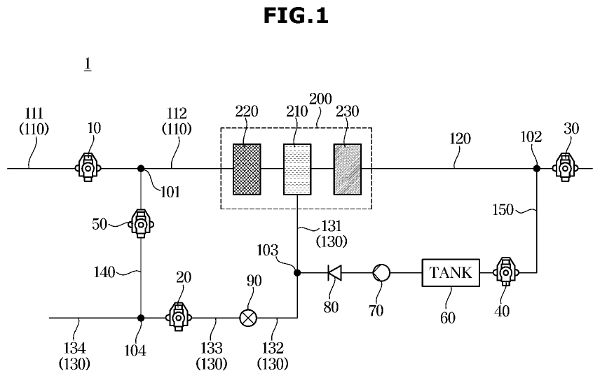

FIG. 1 is a diagram illustrating an example configuration of a water purifier according to various embodiments.

Referring to FIG. 1, a water purifier 1 may include a raw water flow path 110 into which water is introduced from the outside, a filter 200 provided to filter the water introduced from the raw water flow path 110, and a purified water flow path 120 provided to discharge water having passed through the filter 200 to the outside. Water introduced into the water purifier 1 from the outside may be referred to as raw water, and water filtered by the filter 200 may be referred to as purified water. However, raw water and purified water may be referred to as water without being distinguished from each other.

The filter 200 may be arranged on the raw water flow path 110. A raw water valve 10 may be arranged on the raw water flow path 110. The raw water valve 10 may be arranged upstream of the filter 200. As the raw water valve 10 is opened or closed, water in the raw water flow path 110 may or may not flow into the filter 200.

The purified water flow path 120 may be connected to the filter 200. Water introduced into the filter 200 from the raw water flow path 110 and filtered by the filter 200 may flow into the purified water flow path 120. A water outlet valve 30 may be disposed on the purified water flow path 120. As the water outlet valve 30 opens and closes, the water in the purified water flow path 120 may or may not be discharged to the outside of the water purifier 1.

The raw water flow path 110 may be connected to a raw water inlet 200a of the filter 200, which will be described in greater detail below. The purified water flow path 120 may be connected to a purified water outlet 200b of the filter 200, which will be described in greater detail below.

The filter 200 may include a membrane filter 210, a pre-filter 220 disposed upstream of the membrane filter 210, and a post-filter 230 disposed downstream of the membrane filter 210.

The pre-filter 220 may include, for example, and without limitation, at least one of a sediment filter, a high turbidity filter, a carbon filter, a reverse osmosis filter, a micro filtration filter, a nano filtration filter, or the like. The post-filter 230 may include, for example, and without limitation, at least one of a sediment filter, a high turbidity filter, a carbon filter, a reverse osmosis filter, a micro filtration filter, a nano filtration filter, or the like.

According to an embodiment, the filter 200 may include a wastewater flow path therein. The wastewater flow path may refer to a flow path configured to discharge water introduced into the filter 200 that has failed to pass through the pre-filter 220, the membrane filter 210, and the post-filter 230 to the outside of the filter 200. Water in the wastewater flow path may be discharged to the outside of the filter 200 through a wastewater outlet 200c of the filter 200, which will be described in greater detail below.

The water purifier 1 may include a drain flow path 130 connected to the wastewater flow path of the filter 200. The drain flow path 130 may be provided to allow water, which is discharged from the filter 200 through the wastewater flow path, to be discharged to the outside of the water purifier 1.

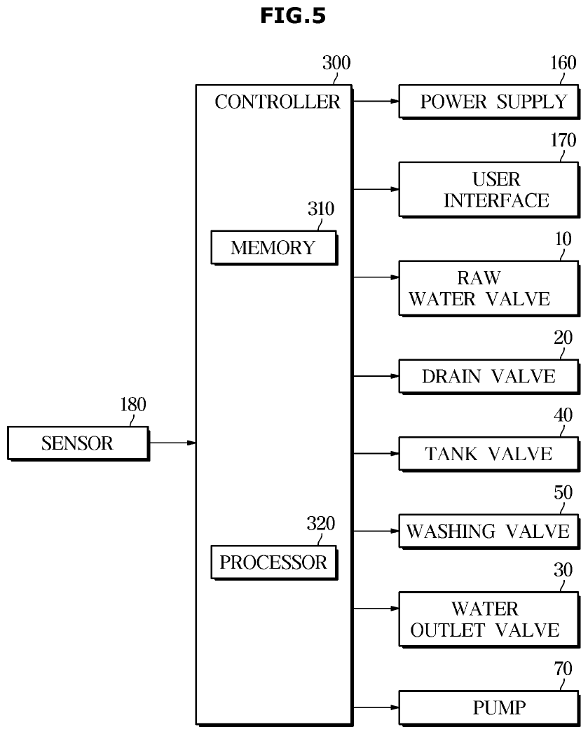

The water purifier 1 may include a resistance valve 90 disposed on the drain flow path 130. The resistance valve 90 may be provided to reduce the flow rate of the drain flow path 130. The resistance valve 90 may be a passive configuration that is not controlled by a controller 300 (refer to FIG. 5), which will be described in greater detail below, and may be provided to allow only a portion of water upstream of the resistance valve 90 to pass downstream of the resistance valve 90. Accordingly, the flow rate on the downstream side of the resistance valve 90 may be relatively low.

The water purifier 1 may include a drain valve 20 disposed downstream of the resistance valve 90 on the drain flow path 130. The drain valve 20 may be disposed between the resistance valve 90 and a connection point 101 of the raw water flow path and a first connection flow path 140.

The water purifier 1 may include the first connection flow path 140 connecting the raw water flow path 110 to a downstream side 133 of the resistance valve on the drain flow path 130. A washing valve 50 may be disposed on the first connection flow path 140.

The water purifier 1 may include a second connection flow path 150 connecting the purified water flow path 120 to upstream sides 131 and 132 of the resistance valve 90 on the drain flow path. A tank 60 may be disposed on the second connection flow path 150. The tank 60 may be provided to store water that has passed through the filter 200.

According to an example embodiment, the tank 60 may be provided to store water for washing the filter 200. The tank 60 may not be provided to store water for drinking by users. Although not shown in FIG. 1, the water purifier 1 may include a storage tank disposed downstream of the connection point 102 between the purified water flow path and the second connection flow path 150. The storage tank may be provided to store water for drinking by users. In other words, although a direct type water purifier is illustrated as the water purifier in FIG. 1, the water purifier according to the present disclosure may, for example, be provided as a tank-type water purifier.

The water outlet valve 30 may be disposed downstream of the connection point 102 between the purified water flow path and the second connection flow path 150 on the purified water flow path 120. In other words, the water outlet valve 30 may be disposed downstream of a second connection flow path branch point 102 of the purified water flow path 120.

The water purifier 1 may include a tank valve 40 disposed upstream of the tank 60 on the second connection flow path 150. The water purifier 1 may include a pump 70 disposed downstream of the tank 60 on the second connection flow path 150. The water purifier 1 may include a check valve 80 disposed downstream of the pump 70 on the second connection flow path 150.

The tank valve 40 may allow or block supply of water to the tank 60 by being opened or closed.

The pump 70 may be provided to move the water inside the tank 60 to the filter 200. The pump 70 may operate to pump water in the tank 60 such that the pumped water moves to the filter 200.

The check valve 80 may allow water discharged from the pump 70 to move downstream of the check valve 80. The check valve 80 may block water in the drain flow path 130 from moving upstream of the check valve 80. Accordingly, the check valve 80 may block water in the drain flow path 130 from flowing into the pump 70 located upstream of the check valve 80.

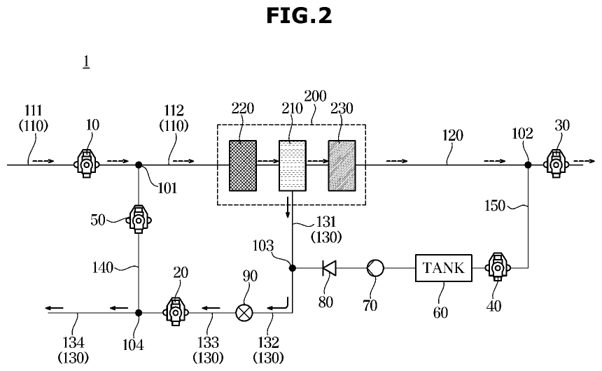

FIG. 2 is a diagram illustrating example flow of water in the water purifier during supply of purified water according to various embodiments.

The flow of water in the water purifier 1 during supply of purified water will be described with reference to FIG. 2.

Supplying purified water refers to filtering water, which is introduced into the filter 200 through the raw water flow path 110, in the filter 200 and then supplying users with the filtered water through the purified water flow path 120 and the water outlet valve 30. This may be referred to as a purified water supply mode.

During supply of purified water, the raw water valve 10 may be opened. As the raw water valve 10 is opened, water in a raw water flow path 111 on an upstream side of the raw water valve 10 may move to a raw water flow path 112 on a downstream side of the raw water valve 10 and flow into the filter 200. The washing valve 50 may be closed to prevent or block water from flowing into the first connection flow path 140.

Water passed through the filter 200 may flow along the purified water flow path 120 and be supplied to the user via the water outlet valve 30. The water outlet valve 30 may be opened for water in the purified water flow path 120 to pass through the water outlet valve 30. The tank valve 40 may be closed to prevent or block water from flowing into the second connection flow path 150.

Water discharged to the drain flow path 130 through the wastewater flow path of the filter 200 may be discharged to the outside of the water purifier 1. In this case, discharge to the outside of the water purifier 1 does not refer to supply to the user.

The water flowing into the drain flow path 131 through the wastewater flow path may pass through the connection point 103 of the drain flow path and the second connection flow path, the resistance valve 90, the drain valve 20, and the connection point 104 of the drain flow path and the first connection flow path, and then exit the water purifier 1. Water introduced into the drain flow path 131 is prevented or blocked from flowing into the second connection flow path 150 due to the check valve 80. The drain valve 20 may be opened such that the water passed through the resistance valve 90 flows through the connection point 104 of the drain flow path and the first connection flow path and, via the downstream side of the drain flow path 134, exit the water purifier 1. As described above, since the washing valve 50 is closed, water passing through the connection point 104 of the drain flow path and the first connection flow path does not flow into the first connection flow path 140.

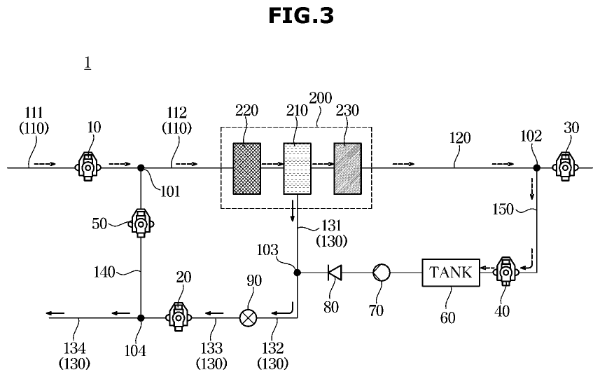

FIG. 3 is a diagram illustrating example flow of water in the water purifier during supply of water to a tank according to various embodiments.

The flow of water in the water purifier 1 during supply of water to the tank will be described with reference to FIG. 3.

Supplying water to the tank may refer to filtering the water, which is introduced into the filter 200 through the raw water flow path 110, in the filter and storing the water that has passed through the purified water flow path 120 and the second connection flow path 150 in the tank 60. During supply of water to the tank, residual water on the purified water flow path 120 may be discharged, and thus supply of water to the tank and discharge of residual water may be simultaneously performed. This may be referred to as a tank supply mode.

During supply of water to the tank, the raw water valve 10 may be opened. As the raw water valve 10 is opened, the water in the raw water flow path 111 on the upstream side of the raw water valve 10 may move to the raw water flow path 112 on the downstream side of the raw water valve 10 and flow into the filter 200. The washing valve 50 may be closed to prevent or block water from flowing into the first connection flow path 140.

Water passed through the filter 200 may pass through the purification flow path 120 and then flow into the second connection flow path 150. The water outlet valve 30 may be closed to prevent or block water from being discharged to the outside of the water purifier 1 through the water outlet valve 30. The tank valve 40 may be opened to allow water to flow into the second connection flow path 150.

Water discharged to the drain flow path 130 through the wastewater flow path of the filter 200 may be discharged to the outside of the water purifier 1. The discharge to the outside of the water purifier 1 does not refer to supply to the user.

The water flowing into the drain flow path 131 through the wastewater flow path may pass through the connection point 103 of the drain flow path and the second connection flow path, the resistance valve 90, the drain valve 20, and the connection point 104 of the drain flow path and the first connection flow path, and then exit the water purifier 1. Water introduced into the drain flow path 131 is prevented or blocked from flowing into the second connection flow path 150 due to the check valve 80. The drain valve 20 may be opened such that the water passed through the resistance valve 90 flows through the connection point 104 of the drain flow path and the first connection flow path and, via the downstream side of the drain flow path 134, exit the water purifier 1. As described above, since the washing valve 50 is closed, water passing through the connection point 104 of the drain flow path and the first connection flow path does not flow into the first connection flow path 140.

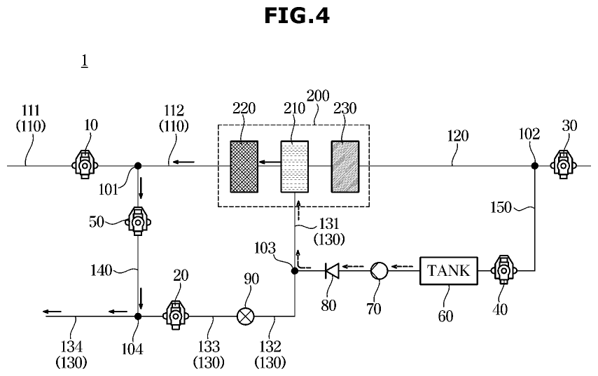

FIG. 4 is a diagram illustrating example flow of water in the water purifier during washing of a filter.

The flow of water in the water purifier 1 during filter washing will be described with reference to FIG. 4.

According to an embodiment, washing a filter may refer to directing water stored in the tank 60 into the filter 200 in a reverse direction to wash the filter 200, and then discharging the water to the outside of the water purifier 1 through the raw water flow path 110, the first connection flow path 140, and the drain flow path 130. Different from the supply of purified water in which water may be supplied into the filter 200 through the raw water flow path 110, water during the washing of the filter may be discharged to the outside of the filter 200 through the raw water flow path 110. Therefore, such a washing may be referred to as back washing. This may be referred to as a filter washing mode.

According to an embodiment, the raw water valve 10 may be closed during washing of the filter. This is because the filter 200 is backwashed using water stored in the tank 60.

The pump 70 may operate to supply the filter 200 with water inside the tank 60. The water inside the tank 60 may be introduced into the filter 200 by the pump 70 to flow through the check valve 80 and the connection point 103 of the drain flow path and the second connection flow path, and then the drain flow path 130. The drain valve 20 may be closed to prevent or block the water inside the tank 60 from flowing toward the resistance valve 90. Due to the resistance of the resistance valve 90 and the closure of the drain valve 20, the water inside the tank 60 may not flow to the downstream side 132 of the drain flow path 130 but flow to the upstream side 131 of the drain flow path 130.

As will be described in greater detail below, when water is introduced into the filter 200 through the drain flow path 130, the water may be introduced into the filter 200 through the wastewater outlet 200c. The water introduced into the filter 200 may be used to backwash the filter 200 and then discharged to the outside of the filter 200 through the raw water inlet 200a.

The water discharged to the outside of the filter 200 through the raw water inlet 200a may be introduced into the raw water flow path 110. Since the water outlet valve 30 and the tank valve 40 are closed, water discharged to the outside of the filter 200 may not flow to the purified water flow path 120. The water flowing into the raw water flow path 110 may pass through the connection point 101 of the raw water flow path and the first connection flow path and then flow into the first connection flow path 140. As the raw water valve 10 is closed, water does not flow to the upstream side 111 of the raw water flow path. The washing valve 50 may be opened to allow water in the first connection flow path 140 to flow into the drain flow path 130. The water in the first connection flow path 140 may pass through the connection point 104 of the drain flow path and the first connection flow path and the downstream side 134 of the drain flow path 130 and exit the water purifier 1. As described above, since the drain valve 20 is closed, water in the first connection flow path 140 may not flow toward the resistance valve 90 at the connection point 104 of the drain flow path and the first connection flow path.

Referring to FIGS. 2 and 4, the direction of movement of water flowing through the raw water flow path 110 during supply of purified water may be opposite to the direction of movement of water flowing through the raw water flow path 110 during washing of filter. For example, the direction of movement of water flowing through the downstream side 112 of the raw water flow path 110 during supply of purified water may be opposite to the direction of movement of water flowing through the downstream side 112 of the raw water flow path 110 during washing of a filter.

Referring to FIGS. 2 and 4, the direction of movement of water flowing through the drain flow path 130 during supply of purified water may be opposite to the direction of movement of water flowing through the drain flow path 130 during washing of a filter. For example, the direction of movement of water flowing through the upstream side 131 of the drain flow path 130 during supply of purified water may be opposite to the direction of movement of water flowing through the upstream side 131 of the drain flow path 130 during washing of a filter.

FIG. 5 is a block diagram illustrating an example configuration for controlling the water purifier according to various embodiments.

The water purifier 1 may include a power supply 160, a user interface (e.g., including various circuitry) 170, a sensor 180, and a controller (e.g., including processing circuitry) 300. Additionally, the water purifier 1 may include a raw water valve 10, a drain valve 20, a tank valve 40, a washing valve 50, an water outlet valve 30, and a pump 70.

The configurations of the water purifier 1 are not limited to those illustrated. Some of the illustrated configurations may be omitted, or other components may be added in addition to the illustrated configurations. For example, the water purifier 1 may further include a communication device including various communication circuitry configured to communicate with an external device.

The controller 300 may be electrically connected to the configurations of the water purifier 1 and control the operation of the water purifier 1. The controller 300 may include a memory 310 and a processor (e.g., including processing circuitry) 320. The memory 310 may memorize/store various types of information necessary for the operation of the water purifier 1. The memory 310 may store instructions, applications, data and/or programs required for the operation of the water purifier 1. For example, the memory 310 may include volatile memory such as a static random access memory (S-RAM) and a dynamic random access memory (D-RAM) for temporarily storing data. In addition, the memory 310 may include a non-volatile memory such as a read only memory (ROM), an erasable programmable read only memory (EPROM), and an electrically erasable programmable read only memory (EEPROM) for long-term storage of data.

The processor 320 may include various processing circuitry and generate a control signal for controlling an operation of the water purifier 1 based on instructions, applications, data, and/or programs stored in the memory 310. The processor 320 may be hardware and may include a logic circuit and an arithmetic circuit. The processor 320 may process data according to a program and/or instructions provided from the memory 310, and may generate a control signal according to a processing result. The memory 310 and the processor 320 may be implemented as one control circuit or as a plurality of circuits. The processor 320 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The power supply 160 may be connected to an external power source and may obtain power required for the operation of the water purifier 1. The power supply 160 may provide power to electronic components included in the water purifier 1. The power supply 160 may include a power circuit and may be electrically connected to the controller 300. The controller 300 may control the power supply 160 and distribute power required for the components of the water purifier 1.

The user interface 170 may include various user interface circuitry including, for example, a display that displays information regarding the status and/or operation of the water purifier 1. The user interface 170 may include an input interface for obtaining user input. Additionally, the user interface 170 may include a speaker that outputs sound.

The display may, for example, and without limitation, be provided as a liquid crystal display (LCD) panel, a light emitting diode (LED) panel, an organic light emitting diode (OLED) panel, or a micro-LED panel. The display device may be provided as a touch display.

The user interface 170 may include various buttons. For example, the input interface may include a water purification button, a water purification stop button, a cold water button, a hot water button, a continuous water discharge button, and/or a filter washing button. A start command or a restart command for a water purification operation may be input through the water purification button. A command to stop the water purification operation may be input through the water purification stop button. A command for a continuous water purification operation may be input through the continuous water discharge button. A filter washing command may be input through the filter washing button.

The user interface 170 may transmit an electrical signal corresponding to the user input to the controller 300.

The sensor 180 may include at least one of a flow rate sensor, an electrical conductivity sensor, or a turbidity sensor. The flow rate sensor may measure the amount of purified water discharged from the filter 200. The flow rate sensor may transmit electrical signals and/or data corresponding to the measured flow rate to the controller 300. The electrical conductivity sensor may measure the electrical conductivity of purified water discharged from the filter 200. The electrical conductivity sensor may transmit electrical signals and/or data corresponding to the measured electrical conductivity to the controller 300. The turbidity sensor may measure the turbidity of purified water discharged from the filter 200. The turbidity sensor may transmit electrical signals and/or data corresponding to the measured turbidity to the controller 300.

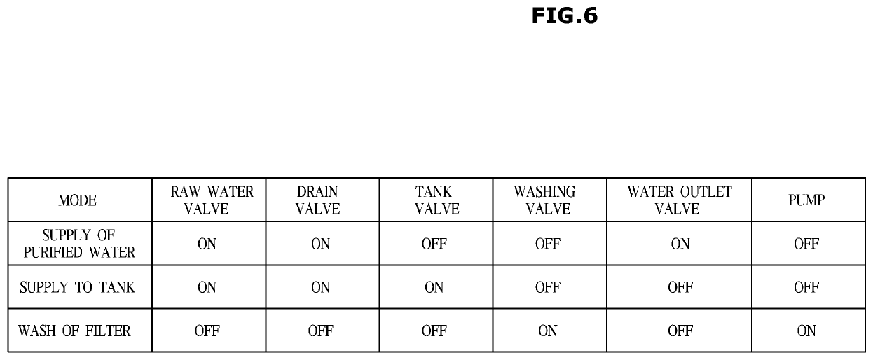

FIG. 6 is a table illustrating an example method of controlling valves and pumps according to each mode in the water purifier according to various embodiments.

Control of valves and pumps in a purified water supply mode, a tank supply mode, and a filter washing mode will be described in greater detail with reference to FIGS. 2, 3, 4 and FIG. 6.

Referring to FIGS. 2 and 6, during supply of purified water, the controller 300 may control the raw water valve 10, the drain valve 20, and the water outlet valve 30 to be opened. The controller 300 may control the tank valve 40 and the washing valve 50 to be closed. The controller 300 may control the pump 70 not to operate.

Based on the control of the controller 300 described above, the water in the raw water flow path 110 may pass through the filter 200 and be discharged to the outside of the water purifier 1 through the water outlet valve 30. The water discharged to the outside of the water purifier 1 through the water outlet valve 30 may be supplied to the user.

Referring to FIGS. 3 and 6, during supply of water to the tank, the controller 300 may control the raw water valve 10, the drain valve 20, and the tank valve 40 to be opened. The controller 300 may control the water outlet valve 30 and the washing valve 50 to be closed. The controller 300 may control the pump 70 not to operate.

Based on the control of the controller 300 described above, the water in the raw water flow path 110 may pass through the filter 200 and then be supplied to the tank 60. Additionally, residual water of the purified water flow path 120 may be supplied to the tank 60.

Referring to FIGS. 4 and 6, during washing of the filter, the controller 300 may control the pump 70 to operate. The controller 300 may control the washing valve 50 to be opened. The controller 300 may control the raw water valve 10, the drain valve 20, the tank valve 40, and the water outlet valve 30 to be closed.

Under the control of the controller 300 described above, the water stored in the tank 60 may pass through the second connection flow path 150 and the drain flow path 130 to backwash the filter 200, and then pass through the raw water flow path 110, the first connection flow path 140, and the drain flow path 130 to exit the water purifier 1.

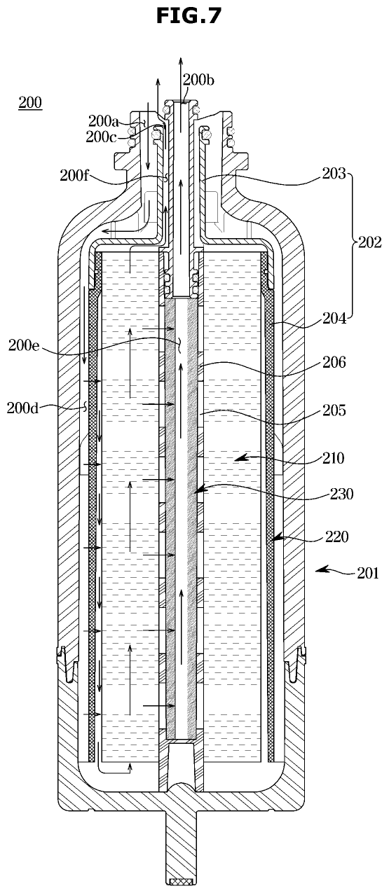

FIG. 7 is a cross-sectional view illustrating example flow of water inside the filter during supply of purified water according to various embodiments.

The structure of the filter 200 of the water purifier according to an embodiment will be described with reference to FIG. 7. Additionally, the flow of water inside the filter 200 during supply of purified water is described.

Referring to FIG. 7, the filter 200 according to an embodiment may include a plurality of filters 210, 220, and 230. For example, the plurality of filters 210, 220, and 230 may include a membrane filter 210, a pre-filter 220, and a post-filter 230.

The filter 200 may include a filter housing 201 provided to accommodate the plurality of filters 210, 220, and 230 therein. According to the embodiment, the filter 200 may include an integrated filter that accommodates the plurality of filters 210, 220, and 230 including the membrane filter 210 within a single filter housing 201. However, the disclosure is not limited to this. The filter 200 may include a membrane filter housing accommodating the membrane filter 210, a pre-filter housing accommodating the pre-filter 220, and a post-filter housing accommodating the post-filter 230.

According to an embodiment, the filter 200 may include a filter case 202 provided inside the filter housing 201.

The filter case 202 may cover a portion of the plurality of filters 210, 220, and 230 without covering a lower end of the plurality of filters 210, 220, and 230. Additionally, a space may be formed between lower end surfaces of the plurality of filters 210, 220, and 230 and the filter housing 201.

The filter case 202 may include an outer case 204 provided to surround the outer periphery of the plurality of filters 210, 220, and 230, and a top case 203 provided at the upper end of the plurality of filters 210, 220, and 230. However, the disclosure is not limited thereto. For example, the filter case 202 may further include other members than the outer case 204 and the top case 203.

The filter case 202 may cover the outer periphery and the upper end of the plurality of filters 210, 220, and 230 to block the flow of fluid. The filter case 202 may prevent or block water filtered by the plurality of filters 210, 220, and 230 from flowing out of the outer periphery or the upper end of the filter case 202 to minimize and/or reduce flow loss.

The filter 200 may include a raw water inlet 200a provided to allow introduction of water from the raw water flow path 110, a purified water outlet 200b provided to discharge water that has passed through the plurality of filters 210, 220, and 230, and a wastewater outlet 200c provided to discharge water from the wastewater flow path inside the filter 200.

During supply of purified water, water in the raw water flow path 110 may flow into the filter 200 through the raw water inlet 200a. Water flowing into the filter 200 through the raw water inlet 200a may flow into the plurality of filters 210, 220, and 230 through a first flow path 200d.

Water in the first flow path 200d may flow into the pre-filter 220. Water failed to pass through the pre-filter 220 may move to a lower end of the membrane filter 210 and then be introduced into the lower end of the membrane filter 210. A portion of the water passed through the pre-filter 220 may pass through the membrane filter 210 and flow into the post-filter 230 located inside of the membrane filter 210. Water failed to pass through the membrane filter 210 may move to an upper end of the membrane filter 210. A portion of the water introduced through the lower end of the membrane filter 210 may flow into the post-filter 230, and a remaining portion may move to the upper end of the membrane filter 210.

The post-filter 230 may be arranged inside a purified water discharge pipe 206 located at the center of the filter 200. Water may be introduced into the post-filter 230 inside the purified water discharge pipe 206 through a through hole 205 of the purified water discharge pipe 206. Water that has passed through the post-filter 230 may flow through a second flow path 200e and, via the purified water outlet 200b, exit the filter 200.

Water that fails to pass through the membrane filter 210 and moved to the upper end of the membrane filter 210 may flow through a third flow path 200f and, via the wastewater outlet 200c, exit the filter 200. A flow path from the lower end of the membrane filter 210 to the upper end of the membrane filter 210 and the third flow path 200f may be referred to as the wastewater flow path as a whole. The wastewater flow path may refer to a flow path that guides water failed to pass through the membrane filter 210 to the wastewater outlet 200c. The wastewater flow path may refer to a flow path for discharging water introduced into the filter 200 that has failed to pass through the membrane filter 210 to the outside through the wastewater outlet 200c.

Water introduced into the membrane filter 210 from the pre-filter 220 or introduced through the lower end of the membrane filter 210 may flow into the third flow path 200f through the upper end of the membrane filter 210, and the water flowing through the third flow path 200f may be discharged to the outside of the filter 200 through the wastewater outlet 200c.

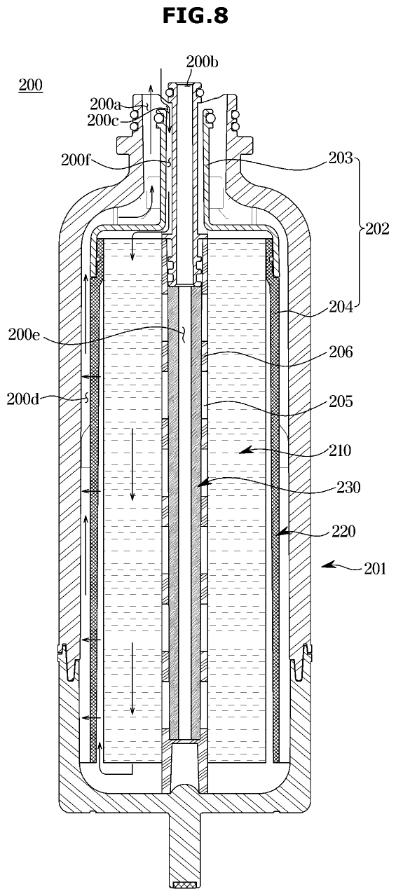

FIG. 8 is a diagram illustrating example flow of water inside the filter during washing of a filter according to various embodiments.

Referring to FIG. 8, during of washing of the filter, water in the drain flow path 130 may flow into the filter 200 through the wastewater outlet 200c. The direction of movement of water in the third flow path 200f during washing of the filter may be opposite to the direction of movement of water in the third flow path 200f during supplying of purified water. Hereinafter, the direction of movement of water opposite to that of water during supply of purified water is referred to as a reverse direction.

Water flowing into the third flow path 200f through the wastewater outlet 200c may flow into the upper end of the membrane filter 210. The water flowing into the upper end of the membrane filter 210 may wash the membrane filter 210. A portion of the water flowing into the upper end of the membrane filter 210 may flow into the pre-filter 220, and a remaining portion may move to the lower end of the membrane filter 210. The water flowing into the pre-filter 220 may wash the pre-filter 220. Water that has passed through the membrane filter 210 and the pre-filter 220 in the reverse direction may pass through the first flow path 200d and, via the raw water inlet 200a, exit the filter 200.

As described above, during supply of purified water, water in the raw water flow path 110 may flow into the first flow path 200d inside the filter 200 through the raw water inlet 200a. The water in the first flow path 200d may flow through the pre-filter 220, the membrane filter 210, and the post-filter 230, and then flow through the second flow path 200e to exit the filter 200 via the purified water outlet 200b, or the water in the first flow path 200d may move to the upper end of the membrane filter 210 and flow through the third flow path 200f to exit the filter 200 via the wastewater outlet 200c.

During washing of the filter, water in the drain flow path 130 may flow into the third flow path 200f inside the filter 200 through the wastewater outlet 200c. The water in the third flow path 200f may pass through the membrane filter 210 and the pre-filter 220 in the reverse direction to wash the membrane filter 210 and the pre-filter 220. The water passed through the membrane filter 210 and the pre-filter 220 in the reverse direction may flow through the first flow path 200d and exit the filter 200 through the raw water inlet 200a.

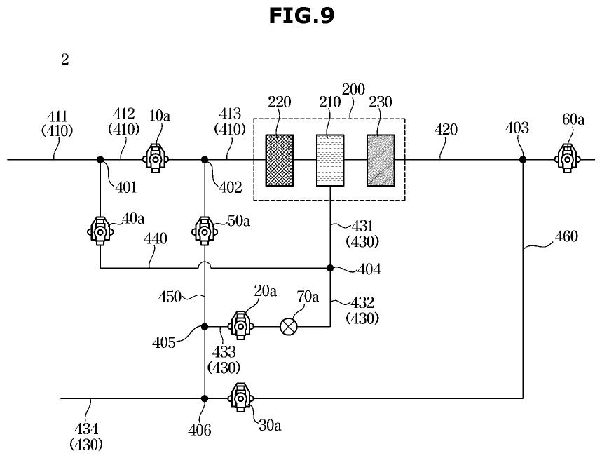

FIG. 9 is a diagram illustrating an example configuration of a water purifier according to various embodiments.

Referring to FIG. 9, a water purifier 2 may include a raw water flow path 410 into which water is introduced from the outside, a filter 200 provided to filter the water introduced from the raw water flow path 410, and a purified water flow path 420 provided to discharge water passed through the filter 200 to the outside. Water introduced into the water purifier 2 from the outside may be referred to as raw water, and water filtered by the filter 200 may be referred to as purified water. However, raw water and purified water may be referred to as water without being distinguished from each other.

The filter 200 may be arranged on the raw water flow path 410. A raw water valve 10a may be arranged on the raw water flow path 410. The raw water valve 10a may be arranged upstream of the filter 200. As the raw water valve 10a is opened or closed, water in the raw water flow path 410 may or may not flow into the filter 200.

The raw water valve 10a may be disposed between a connection point 401 of the raw water flow path and a first connection flow path 440 and a connection point 402 of the raw water flow path and a second connection flow path 450. The first connection flow path 440 and the second connection flow path 450 are described in greater detail below.

The purified water flow path 420 may be connected to the filter 200. Water introduced into the filter 200 from the raw water flow path 410 and then filtered by the filter 200 may flow into the purified water flow path 420. A water outlet valve 60a may be disposed on the purified water flow path 420. As the water outlet valve 60a opens and closes, the water in the purified water flow path 420 may or may not be discharged to the outside of the water purifier 2.

The raw water flow path 410 may be connected to the raw water inlet 200a of the filter 200 described above. The purified water flow path 420 may be connected to the purified water outlet 200b of the filter 200 described above.

The filter 200 may include a membrane filter 210, a pre-filter 220 disposed upstream of the membrane filter 210, and a post-filter 230 disposed downstream of the membrane filter 210.

The pre-filter 220 may include, for example, and without limitation, at least one of a sediment filter, a high turbidity filter, a carbon filter, a reverse osmosis filter, a micro filtration filter, a nano filtration filter, or the like. The post-filter 230 may include, for example, and without limitation, at least one of a sediment filter, a high turbidity filter, a carbon filter, a reverse osmosis filter, a micro filtration filter, a nano filtration filter, or the like.

According to an embodiment, the filter 200 may include a wastewater flow path therein. The wastewater flow path may refer to a flow path that allows water flowing into the filter 200 that failed to pass through the pre-filter 220, the membrane filter 210, and the post-filter 230 to be discharged to the outside of the filter 200. Water in the wastewater flow path may be discharged to the outside of the filter 200 through a wastewater outlet 200c of the filter 200, which will be described in greater detail below.

The water purifier 2 may include a drain flow path 430 connected to the wastewater flow path of the filter 200. The drain flow path 430 may be provided to allow water, which is discharged from the filter 200 through the wastewater flow path, to be discharged to the outside of the water purifier 2.

The water purifier 2 may include a resistance valve 70a disposed on the drain flow path 430. The resistance valve 70a may be provided to reduce the flow rate of the drain flow path 430. The resistance valve 70a is a passive configuration that is not controlled by the controller 300, and may be provided to allow only a portion of water upstream of the resistance valve 70a to pass downstream of the resistance valve 70a. Accordingly, the flow rate on the downstream side of the resistance valve 70a may be relatively low.

The water purifier 2 may include a first drain valve 20a disposed downstream of the resistance valve 70a on the drain flow path 430. The first drain valve 20a may be disposed between the resistance valve 70a and a connection point 405 of the drain flow path and a second connection flow path.

The water purifier 2 may include a first connection flow path 440 connecting the raw water flow path 410 to upstream sides 431 and 432 of the resistance valve on the drain flow path 430. A first washing valve 40a may be disposed on the first connection flow path 440.

The water purifier 2 may include a second connection flow path 450 that bypasses the first connection flow path 440 and connects the raw water flow path 410 to a downstream side 433 of the drain valve 20a on the drain flow path 430. A second washing valve 50a may be disposed on the second connection flow path 450.

The water purifier 2 may include a third connection flow path 460 connecting the purified water flow path 420 to a downstream side 434 of the drain flow path 430, which is a side downstream of the connection point 405 between the drain flow path and the second connection flow path on the drain flow path 430. A second drain valve 30a may be disposed on the third connection flow path 460.

A water outlet valve 60a may be disposed downstream of a connection point 403 of the purified water flow path and the third connection flow path 460, on the purified water flow path 420. In other words, the water outlet valve 60a may be disposed downstream of a third connection flow path branch point 403 of the purified water flow path 420.

Although not shown in FIG. 9, the water purifier 2 may include a storage tank disposed downstream of the connection point 403 between the purified water flow path and the third connection flow path 460. The storage tank may be provided to store water for drinking by users. In other words, although a direct water purifier is illustrated as the water purifier in FIG. 9, the water purifier according to the disclosure may be provided as a tank-type water purifier.

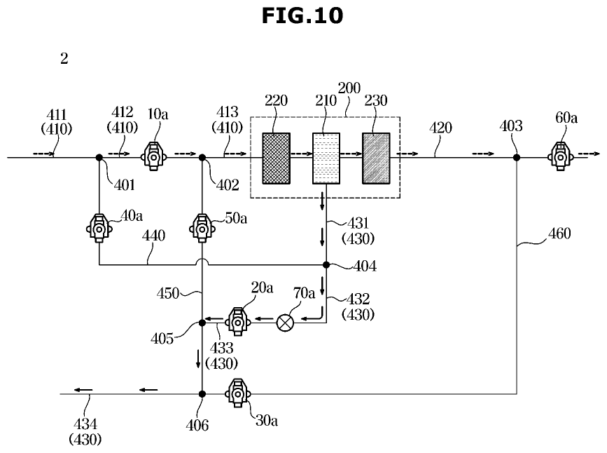

FIG. 10 is a diagram illustrating example flow of water in a water purifier during supply of purified water according to various embodiments.

The flow of water in the water purifier 2 during supply of purified water will be described with reference to FIG. 10.

Supplying purified water may refer to filtering water, which is introduced into the filter 200 through the raw water flow path 410, in the filter 200 and supplying users with the filtered water through the purified water flow path 420 and the water outlet valve 60a. This may be referred to as a purified water supply mode.

During supply of purified water, the raw water valve 10a may be opened. As the raw water valve 10a is opened, water in raw water flow paths 411 and 412 on the upstream side of the raw water valve 10a may move to a raw water flow path 413 on the downstream side of the raw water valve 10a and flow into the filter 200. The first washing valve 40a may be closed to prevent or block water from flowing into the first connection flow path 440. The second washing valve 50a may be closed to prevent or block water from flowing into the second connection flow path 450.

Water filtered through the filter 200 may pass through the purified water flow path 420 and, via the water outlet valve 60a, be supplied to the user. The water outlet valve 60a may be opened to allow water in the purified water flow path 420 to pass through the water outlet valve 60a. The second drain valve 30a may be closed to prevent or block water from flowing into the third connection flow path 460.

Water discharged to the drain flow path 430 through the wastewater flow path of the filter 200 may be discharged to the outside of the water purifier 2. In this case, discharge to the outside of the water purifier 2 does not refer to supply to the user.

The water flowing into the upstream side 431 of the drain flow path 430 through the wastewater flow path may pass through the connection point 404 between the drain flow path and the first connection flow path, the resistance valve 70a, the first drain valve 20a, and the connection point 405 between the drain flow path and the second connection flow path, to exit the water purifier 2. As the first washing valve 40a is closed, water flowing into the upstream side 431 of the drain flow path 430 does not flow into the first connection flow path 440. The first drain valve 20a may be opened such that the water that has passed through the resistance valve 70a passes through the first drain valve 20a and exits the water purifier 2. Since the second washing valve 50a is closed, water passing through the connection point 405 between the drain flow path and the second connection flow path does not flow into the second connection flow path 450. Additionally, since the second drain valve 30a is closed, water passing through the connection point 406 between the drain flow path and the third connection flow path does not flow into the third connection flow path 460. Accordingly, water may be discharged to the outside of the water purifier 2 through the downstream side 434 of the drain flow path 430.

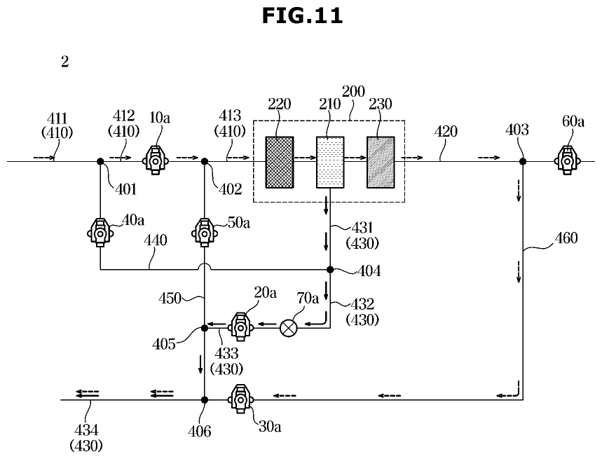

FIG. 11 is a diagram illustrating example flow of water in the water purifier during discharge of residual water according to various embodiments.

The flow of water in the water purifier 2 when discharging residual water will be described with reference to FIG. 11.

Discharge of residual water may refer to filtering water, which is introduced into the filter 200 through the raw water flow path 410, in the filter 200 and then discharging the water to the outside of the water purifier 2 through the purified water flow path 420 and the third connection flow path 460. This may be referred to as a residual water discharge mode. This is to remove residual water remaining in the purified water flow path 420 by discharging the residual water before supplying purified water.

During discharge of residual water, the raw water valve 10a may be opened. As the raw water valve 10a is opened, the water in the raw water flow paths 411 and 412 on the upstream side of the raw water valve 10a may move to the raw water flow path 413 on the downstream side of the raw water valve 10a and flow into the filter 200. The first washing valve 40a may be closed to prevent or block water from flowing into the first connection flow path 440. The second washing valve 50a may be closed to prevent or block water from flowing into the second connection flow path 450.

Water that has passed through the filter 200 may pass through the purification flow path 420 and flow into the third connection flow path 460. The water outlet valve 60a may be closed such that the water in the purified water flow path 420 is not discharged to the outside of the water purifier 2 through the water outlet valve 60a. The second drain valve 30a may be opened to allow water to flow into the third connection flow path 460. The water that has passed through the second drain valve 30a may pass through the downstream side 434 of the drain flow path 430 and exit the water purifier 2. As described above, since the second washing valve 50a is closed, the water passing through the second drain valve 30a does not flow into the second connection flow path 450. As will be described in greater detail below, the first drain valve 20a is opened, but the water passed through the second drain valve 30a does not flow to the upstream sides 432 and 431 of the drain flow path 430 due to the resistance valve 70a.

Water discharged to the drain flow path 430 through the wastewater flow path of the filter 200 may be discharged to the outside of the water purifier 2. In this case, discharge to the outside of the water purifier 2 does not refer to supply to the user.

The water flowing into the upstream side 431 of the drain flow path 430 through the wastewater flow path may pass through the connection point 404 between the drain flow path and the first connection flow path, the resistance valve 70a, the first drain valve 20a, and the connection point 405 between the drain flow path and the second connection flow path, and then exit the water purifier 2. As the first washing valve 40a is closed, water flowing into the upstream side 431 of the drain flow path 430 does not flow into the first connection flow path 440. The first drain valve 20a may be opened such that the water that has passed through the resistance valve 70a passes through the first drain valve 20a and then exits the water purifier 2. Since the second washing valve 50a is closed as described above, water passing through the connection point 405 between the drain flow path and the second connection flow path 450 does not flow into the second connection flow path 450. Although the second drain valve 30a is opened as described above, the water passing through the connection point 406 between the drain flow path and the third connection flow path does not move to the third connection flow path 460 due to the pressure of the water discharged through the second drain valve 30a. Accordingly, the water may be discharged to the outside of the water purifier 2 through the downstream side 434 of the drain flow path 430.

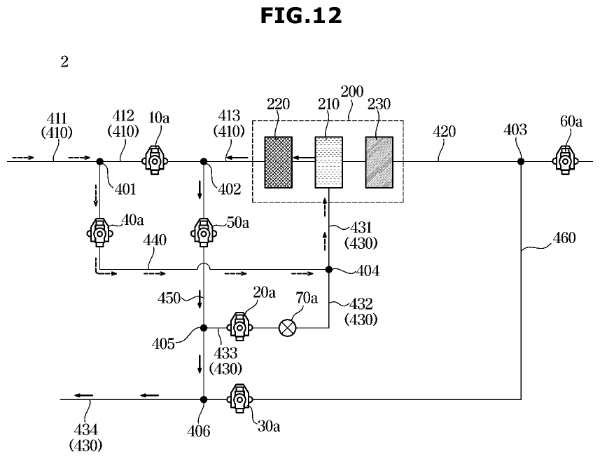

FIG. 12 is a diagram illustrating example flow of water in the water purifier during washing of a filter according to various embodiments.

The flow of water in the water purifier 2 during filter washing will be described with reference to FIG. 12.

According to an embodiment, washing a filter may refer to directing water of the raw water flow path 410 into the filter 200 through the first connection flow path 440 and the drain flow path 430 in the reverse direction to wash the filter 200, and then discharging the water to the outside of the water purifier 2 through the raw water flow path 110, the second connection flow path 450, and the drain flow path 430. Different from the supply of purified water in which water may be supplied into the filter 200 through the raw water flow path 410, water during washing of a filter may be discharged to the outside of the filter 200 through the raw water flow path 410. Therefore, such a washing may be referred to as back washing. This may be referred to as a filter washing mode.

According to an embodiment, during washing of a filter, the raw water valve 10a may be closed, and the first washing valve 40a and the second washing valve 50a may be opened. As the raw water valve 10a is closed and the first washing valve 40a is opened, water on the upstream side 411 of the raw water flow path 410 may be introduced into the first connection flow path 440. The water introduced into the first connection flow path 440 may be introduced into the filter 200 through the upstream side 431 of the drain flow path 430 in the reverse direction. The first drain valve 20a may be closed to prevent or block water in the first connection flow path 440 from flowing toward the resistance valve 70a and the first drain valve 20a of the drain flow path 430.

As described above, when water flows into the filter 200 through the drain flow path 430, the water may flow into the filter 200 through the wastewater outlet 200c. The water flowing into the filter 200 may backwash the filter 200 and then be discharged to the outside of the filter 200 through the raw water inlet 200a.

The water discharged to the outside of the filter 200 through the raw water inlet 200a may be introduced into the raw water flow path 410. Since the water outlet valve 60a and the second drain valve 30a are closed, water discharged to the outside of the filter 200 may not flow into the purified water flow path 420. The water flowing into the downstream side 413 of the raw water flow path 110 may pass through the connection point 402 between the raw water flow path and the second connection flow path 450 and then flow into the second connection flow path 450. This is because as the raw water valve 10a is closed, water does not flow to the upstream sides 411 and 412 of the raw water flow path. The second washing valve 50a may be opened to allow water in the second connection flow path 450 to flow into the drain flow path 430. The water in the second connection flow path 450 may pass through the connection point 405 between the drain flow path and the second connection flow path, and the connection point 406 between the drain flow path and the third connection flow path, and then exit the water purifier 2. As described above, because the first drain valve 20a is closed, the water in the second connection flow path 450 may not flow toward the resistance valve 70a at the connection point 405 between the drain flow path and the second connection flow path. Since the second drain valve 30a is closed, water in the second connection flow path 450 may not flow toward the second drain valve 30a at the connection point 406 between the drain flow path and the third connection flow path.

Referring to FIGS. 10 and 12, the direction of movement of water flowing through the raw water flow path 410 during supply of purified water may be opposite to the direction of movement of water flowing through the raw water flow path 410 during washing of a filter. For example, the direction of movement of water flowing through the downstream side 413 of the raw water flow path 410 during supply of purified water may be opposite to the direction of movement of water flowing through the downstream side 413 of the raw water flow path 410 during washing of a filter.

Referring to FIGS. 10 and 12, the direction of movement of water flowing through the drain flow path 430 during supply of purified water may be opposite to the direction of movement of water flowing through the drain flow path 430 during washing of a filter. For example, the direction of movement of water flowing through the upstream side 431 of the drain flow path 130 during supply of purified water may be opposite to the direction of movement of water flowing through the upstream side 431 of the drain flow path 130 during washing of a filter.

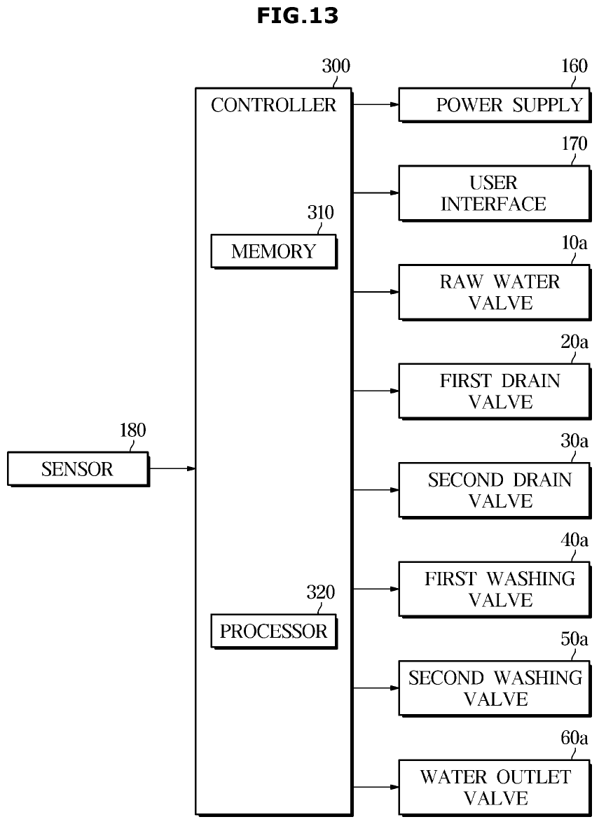

FIG. 13 is a block diagram illustrating an example configuration of the water purifier according to various embodiments.

The water purifier 2 may include a power supply 160, a user interface (e.g., including various circuitry) 170, a sensor 180, and a controller (e.g., including processing/control circuitry) 300. In addition, the water purifier 2 includes a raw water valve 10a, a first drain valve 20a, a second drain valve 30a, a first wash valve 40a, a second wash valve 50a, and a water outlet valve 60a.

The configurations of the water purifier 2 are not limited to those illustrated. Some of the illustrated components may be omitted, or other components may be added in addition to the illustrated configurations. For example, the water purifier 2 may further include a communication device to communicate with an external device.

The controller 300 may be electrically connected to the configurations of the water purifier 2 and control the operation of the water purifier 2. The controller 300 may include a memory 310 and a processor 320. In the following description, parts identical or similar to those described may not be repeated.

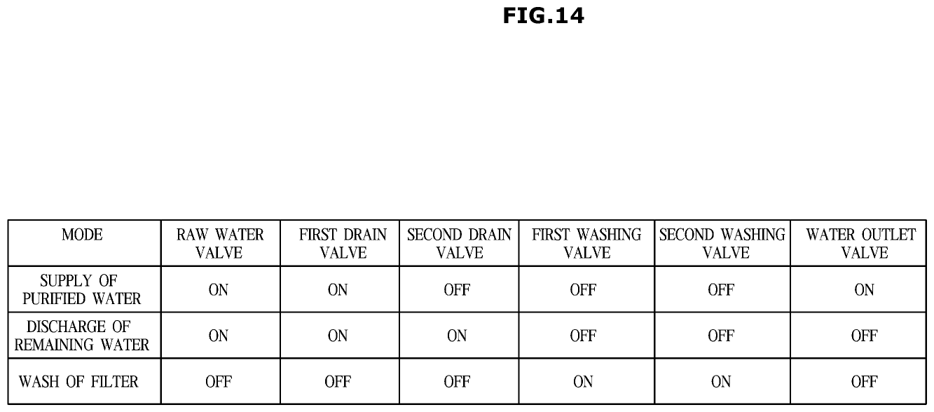

FIG. 14 is a table illustrating an example method of controlling valves according to each mode in the water purifier according to various embodiments.

Control of valves in a purified water supply mode, a residual water discharge mode, and a filter washing mode will be described with reference to FIGS. 10 to 12 and FIG. 14.

Referring to FIGS. 10 and 14, during supply of purified water, the controller 300 may control the raw water valve 10a, the first drain valve 20a, and the water outlet valve 60a to be opened. The controller 300 may control the second drain valve 30a, the first washing valve 50a, and the second washing valve 60a to be closed.

Based on the control of the controller 300 described above, the water in the raw water flow path 410 may pass through the filter 200 and, via the water outlet valve 60a, be discharged to the outside of the water purifier 2. The water discharged to the outside of the water purifier 2 through the water outlet valve 60a may be supplied to the user.

Referring to FIGS. 11 and 14, during discharge of residual water, the controller 300 may control the raw water valve 10a, the first drain valve 20a, and the second drain valve 30a to be opened. The controller 300 may control the first washing valve 40a, the second washing valve 50a, and the water outlet valve 60a to be closed.

Based on the control of the controller 300 described above, the water in the raw water flow path 410 may pass through the filter 200 and then be supplied to the third connection flow path 460. Water flowing into the third connection flow path 460 may be discharged to the outside of the water purifier 2 through the drain flow path 430.

Referring to FIGS. 12 and 14, during washing of the filter, the controller 300 may control the first washing valve 20a and the second washing valve 20b to be opened. The controller 300 may control the raw water valve 10a, the first drain valve 20a, the second drain valve 30a, and the water outlet valve 60a to be closed.

Based on the control of the controller 300 described above, the water in the raw water flow path 410 may pass through the first connection flow path 440 and the drain flow path 430 to backwash the filter 200 and, via the raw water flow path 410, the second connection flow path 450, and the drain flow path 430, exit the water purifier 2.

According to an example embodiment, a water purifier includes: a raw water flow path, including at least one valve, configured to receive water from outside; a filter configured to filter the water introduced from the raw water flow path, and including a wastewater flow path therein; a purified water flow path, including at least one valve, through which the water having passed through the filter is configured to be discharged to the outside; a drain flow path, including at least one valve, connected to the wastewater flow path of the filter and through which the water discharged from the filter through the wastewater flow path is configured to be discharged; a resistance valve arranged on the drain flow path configured to reduce a flow rate of the drain flow path; a first connection flow path, including at least one valve, connecting the raw water flow path to a downstream side of the resistance valve on the drain flow path; a second connection flow path, including at least one valve, connecting the purified water flow path to an upstream side of the resistance valve on the drain flow path; and a tank configured to store water passed through the filter, and arranged on the second connection flow path, wherein during washing of the filter, the water stored in the tank is configured to flow into the filter via the upstream side of the resistance valve on the drain flow path, and the water flowing into and through the filter is configured to be discharged to the outside through the raw water flow path, the first connection flow path, and the downstream side of the resistance valve on the drain flow path.

During washing of the filter, the water stored in the tank may be configured to flow into the filter without passing through the resistance valve, and the water flowing into and through the filter may be configured to be discharged to the outside of the water purifier without passing through the resistance valve.

The filter may include a raw water inlet configured to allow introduction of water of the raw water flow path, a purified water outlet configured to discharge water flowing through inside of the filter, and a wastewater outlet configured to discharge water of the wastewater flow path.

During washing of the filter, water stored in the tank may be configured to be introduced into the filter through the wastewater outlet and may be configured to be discharged to the outside of the filter through the raw water inlet.

A direction of movement of water flowing through the raw water flow path and the upstream side of the resistance valve on the drain flow path during supply of purified water may be opposite to a direction of movement of water flowing through the raw water flow path and the upstream side of the resistance valve on the drain flow path during washing of the filter.

The water purifier may further include a raw water valve arranged upstream of a connection point of the raw water flow path and the first connection flow path, on the raw water flow path.

The water purifier may further include a drain valve arranged between the resistance valve and a connection point of the drain flow path and the first connection flow path, on the drain flow path.

The water purifier may further include a washing valve arranged on the first connection flow path.

The water purifier may further include a tank valve arranged upstream of the tank, on the second connection flow path.

The water purifier may further include a water outlet valve arranged downstream of a connection point between the purified water flow path and the second connection flow path, on the purified water flow path.

The water purifier may further include a controller, comprising at least one processor, comprising processing circuitry, individually and/or collectively configured to control opening and closing of the raw water valve, the drain valve, the washing valve, the tank valve, and the water outlet valve.

During supply of purified water, at least one processor, individually and/or collectively, may be configured to control the raw water valve, the drain valve, and the water outlet valve to be opened, and control the tank valve and the washing valve to be closed, and under control of at least one processor, individually and/or collectively, the water in the raw water flow path may pass through the filter, and via the purified water flow path and the water outlet valve, exit the water purifier.

During supply of water to the tank, at least one processor, individually and/or collectively, may be configured to control the raw water valve, the drain valve, and the tank valve to be opened, and control the water outlet valve and the washing valve to be closed, and under control of at least one processor, individually and/or collectively, the water in the raw water flow path 110 may pass through the filter, and via the purified water flow path and the second connection flow path, be supplied to the tank.

The water purifier may further include a pump arranged downstream of the tank on the second connection flow path, and configured to move water inside the tank to the filter.

During of washing of the filter, at least one processor, individually and/or collectively, may be configured to control the pump to operate, control the washing valve to be opened, and control the raw water valve, the drain valve, the tank valve, and the water outlet valve to be closed.

Under control of at least one processor, individually and/or collectively, the water stored in the tank may pass through the second connection flow path and the upstream side of the resistance valve on the drain flow path to wash the filter, and then pass through the raw water flow path, the first connection flow path, and the downstream side of the resistance valve on the drain flow path to exit the water purifier.

The water purifier may further include a check valve arranged downstream of the pump on the second connection flow path.

The check valve may be configured to allow water discharged from the pump to move to a downstream side of the check valve, and block water in the drain flow path from flowing into the pump located on an upstream side of the check valve.

The filter may include a membrane filter.

During washing of the filter, the water purifier may be configured to wash the membrane filter.

The filter may further include a pre-filter arranged on an upstream side of the membrane filter and a post-filter arranged on a downstream side of the membrane filter.

During washing of the filter, the water purifier may be configured to wash the membrane filter and the pre-filter.

The filter may further include a filter housing configured to accommodate the pre-filter, the membrane filter, and the post-filter.

Each of the pre-filter and the post-filter may include at least one of a sediment filter, a high turbidity filter, a carbon filter, a reverse osmosis filter, a micro filtration filter, or a nano filtration filter.

A water purifier according to an example embodiment includes: a raw water flow path, including at least one valve, configured to receive water from the outside; a filter configured to filter water introduced from the raw water flow path and including a wastewater flow path therein; a purified water flow path, including at least one valve, configured to discharge the water passed through the filter to the outside; a drain flow path, including at least one valve, connected to the wastewater flow path of the filter and configured to discharge wastewater along which water discharged from the filter through the wastewater flow path; a resistance valve arranged on the drain flow path and configured to reduce a flow rate of the drain flow path; a first connection flow path, including at least one valve, connecting the raw water flow path to a upstream side of the resistance valve on the drain flow path; and a second connection flow path, including at least one valve, connecting the raw water flow path to the drain flow path while bypassing the first connection flow path, the second connection flow path configured to connect a downstream side of a branch point of the first connection flow path on the raw water flow path to a downstream side of the resistance valve on the drain flow path. During washing of the filter, water in the raw water flow path may be introduced into the filter through the first connection flow path and an upstream side of the resistance valve on the drain flow path, and the water flowing into and through the filter may be discharged to the outside through the raw water flow path, the second connection flow path, and a downstream side of the resistance valve on the drain flow path.

During washing of the filter, the water in the raw water flow path may be introduced into the filter without passing through the resistance valve, and the water discharged from the filter via the inside of the filter may be discharged to the outside of the water purifier without passing through the resistance valve.

The water purifier may include a raw water valve disposed between a connection point of the raw water flow path and the first connection flow path and a connection point of the raw water flow path and the second connection flow path, on the raw water flow path.

The water purifier may further include a first drain valve disposed between the resistance valve and a connection point of the drain flow path and the second connection flow path on the drain flow path.

The water purifier may further include a first washing valve disposed on the first connection flow path.

The water purifier may further include a second washing valve disposed on the second connection flow path.

The water purifier may further include a water outlet valve disposed on the purified water flow path.

The water purifier may further include a third connection flow path, comprising at least one valve, connecting an upstream side of the water outlet valve on the purified water flow path to a downstream side of the branch point of the second connection flow path on the drain flow path.

The water purifier may further include a second drain valve disposed on the third connection flow path.

The water purifier may further include a controller, comprising at least one processor, comprising processing circuitry, individually and/or collectively, configured to control opening and closing of the raw water valve, the first drain valve, the first washing valve, the second washing valve, the water outlet valve, and the second drain valve.

During washing of the filter, at least one processor, individually and/or collectively, may control the first washing valve and the second washing valve to be opened and control the raw water valve, the drain valve, and the water outlet valve to be closed.

Under control of at least one processor, individually and/or collectively, water in the raw water flow path may pass through the first connection flow path and the upstream side of the resistance valve on the drain flow path, flow into the filter, and wash the filter, after which, the water discharged from the filter may pass through the raw water flow path, the second connection flow path, and the downstream side of the resistance valve on the drain flow path, and exit the water purifier.

During supply of purified water, at least one processor, individually and/or collectively, may be configured to control the raw water valve, the first drain valve, and the water outlet valve to be opened, and control the second drain valve, the first washing valve, and the second washing valve to be closed.

Under control of at least one processor, individually and/or collectively, the water in the raw water flow path may pass through the filter and then through the purified water flow path and the water outlet valve, exit the water purifier.

During discharge of residual water, at least one processor, individually and/or collectively, may be configured to control the raw water valve, the first drain valve, and the second drain valve to be opened, and control the first wash valve, the second wash valve, and the water outlet valve to be closed.

Under control of at least one processor, individually and/or collectively, the water in the raw water flow path may pass through the filter and then through the water purification flow path, the third connection flow path, and the downstream side of the resistance valve on the drain flow path, exit the water purifier.

The filter may include: a raw water inlet configured to allow introduction of water of the raw water flow path; a purified water outlet configured to discharge water that has passed through the inside of the filter; and a wastewater outlet configured to discharge water of the wastewater flow path.

During washing of the filter, water in the raw water flow path be introduced into the filter through the wastewater outlet and discharged to the outside of the filter through the raw water inlet.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A water purifier comprising:
a raw water flow path configured to receive water from outside;
a filter configured to filter the water introduced from the raw water flow path, and including a wastewater flow path therein;
a purified water flow path configured to discharge water having passed through the filter to the outside;
a drain flow path connected to the wastewater flow path of the filter and configured to discharge the water discharged from the filter through the wastewater flow path;
a resistance valve arranged on the drain flow path and configured to reduce a flow rate of the drain flow path;
a first connection flow path connecting the raw water flow path to a downstream side of the resistance valve on the drain flow path;
a second connection flow path connecting the purified water flow path to an upstream side of the resistance valve on the drain flow path; and
a tank configured to store water passed through the filter, and arranged on the second connection flow path,
wherein during washing of the filter,
the water stored in the tank is configured to flow into the filter via the upstream side of the resistance valve on the drain flow path, and
the water flowing into and through the filter is configured to be discharged to the outside through the raw water flow path, the first connection flow path, and the downstream side of the resistance valve on the drain flow path.

2. The water purifier of claim 1, wherein during washing of the filter, the water stored in the tank is configured to flow into the filter without passing through the resistance valve, and the water flowing into and through the filter is configured to be discharged to the outside of the water purifier without passing through the resistance valve.

3. The water purifier of claim 1, wherein the filter includes
a raw water inlet configured to allow introduction of water of the raw water flow path,
a purified water outlet configured to discharge water flowing through inside of the filter, and
a wastewater outlet configured to discharge water of the wastewater flow path,
wherein during washing of the filter, water stored in the tank is configured to be introduced into the filter through the wastewater outlet and discharged to the outside of the filter through the raw water inlet.

4. The water purifier of claim 1, wherein a direction of movement of water flowing through the raw water flow path and the upstream side of the resistance valve on the drain flow path during supply of purified water is opposite to a direction of movement of water flowing through the raw water flow path and the upstream side of the resistance valve on the drain flow path during washing of the filter.

5. The water purifier of claim 1, further comprising:
a raw water valve arranged upstream of a connection point of the raw water flow path and the first connection flow path, on the raw water flow path;
a drain valve arranged between the resistance valve and a connection point of the drain flow path and the first connection flow path, on the drain flow path;
a washing valve arranged on the first connection flow path;
a tank valve arranged upstream of the tank, on the second connection flow path;
a water outlet valve arranged downstream of a connection point between the purified water flow path and the second connection flow path, on the purified water flow path; and
a controller, comprising at least one processor, comprising processing circuitry, individually and/or collectively, configured to control opening and closing of the raw water valve, the drain valve, the washing valve, the tank valve, and the water outlet valve.

6. The water purifier of claim 5, wherein during supply of purified water, at least one processor, individually and/or collectively, is configured to:
control the raw water valve, the drain valve, and the water outlet valve to be opened, and control the tank valve and the washing valve to be closed; and
control the water in the raw water flow path to pass through the filter, and via the purified water flow path and the water outlet valve, to exit the water purifier.

7. The water purifier of claim 5, wherein during supply of water to the tank, at least one processor, individually and/or collectively, is configured to:
control the raw water valve, the drain valve, and the tank valve to be opened, and control the water outlet valve and the washing valve to be closed; and
control the water in the raw water flow path to through the filter and, via the purified water flow path and the second connection flow path, and be supplied to the tank.

8. The water purifier of claim 5, further comprising a pump arranged downstream of the tank on the second connection flow path, and configured to move water inside the tank to the filter,
during of washing of the filter, at least one processor, individually and/or collectively, is configured to control the pump to operate, control the washing valve to be opened, and control the raw water valve, the drain valve, the tank valve, and the water outlet valve to be closed, and
control the water stored in the tank to pass through the second connection flow path and the upstream side of the resistance valve on the drain flow path to wash the filter, and then passes through the raw water flow path, the first connection flow path, and the downstream side of the resistance valve on the drain flow path to exit the water purifier.

9. The water purifier of claim 8, further comprising a check valve arranged downstream of the pump on the second connection flow path,
wherein the check valve is configured to allow water discharged from the pump to move to a downstream side of the check valve, and block water in the drain flow path from flowing into the pump located on an upstream side of the check valve.

10. The water purifier of claim 1, wherein the filter includes a membrane filter, wherein
during washing of the filter, the membrane filter is configured to be washed.

11. The water purifier of claim 10, wherein the filter further incudes
a pre-filter arranged on an upstream side of the membrane filter and a post-filter arranged on a downstream side of the membrane filter,
wherein during washing of the filter, the membrane filter and the pre-filter are configured to be washed.

12. The water purifier of claim 11, wherein the filter further includes a filter housing configured to accommodate the pre-filter, the membrane filter, and the post-filter.

13. The water purifier of claim 11, wherein each of the pre-filter and the post-filter includes at least one of a sediment filter, a high turbidity filter, a carbon filter, a reverse osmosis filter, a micro filtration filter, or a nano filtration filter.
